(19) United States
(12) Patent Application Publication
(10) Pub. No.: US 2020/0125351 A1
(43) Pub. Date: Apr. 23, 2020

(54) CLONING APPLICATION INSTANCES DEPLOYED ON MAINFRAME COMPUTING SYSTEMS

(71) Applicant: CA, Inc., Islandia, NY (US)

(72) Inventors: Pavel Zlatnik, Prague 6 (CZ); Adrian Bastyr, Kresice (CZ); Marketa Muzikova, Praha 4 (CZ); Vitezslav Vit Vlcek, Prague (CZ)

(73) Assignee: CA, Inc., Islandia, NY (US)

(21) Appl. No.: 16/165,894

(22) Filed: Oct. 19, 2018

(51) Int. Cl. G06F 8/65; H04L 29/08

(52) U.S. Cl. CPC G06F 8/65; H04L 67/34

(57) ABSTRACT

According to at least one embodiment, an auto-discovery process is initiated to gather configuration information for a first instance of an application deployed on a mainframe computing system. A mainframe management agent of the mainframe computing system generates, using the configuration information gathered during the auto-discovery process, an image of the first instance of the application at the application layer. The image indicates a set of application artifacts and variables defining a runtime environment for the first instance of the application. A cloning template, which defines a workflow for cloning the application instance at a second mainframe computing system and indicates a set of application artifacts and variables to define a runtime environment for the application instance, is accessed, and a second instance of the application is provisioned on the second mainframe computing system based on the cloning template and the image of the first instance of the application.

### BACKGROUND

The present disclosure relates in general to the field of computing systems, and more specifically, to upgrading and cloning application instances deployed on mainframe computing systems.

In mainframe computing environments, software release upgrades (e.g., upgrading a deployed application instance to a new version of the application) and software transfers between mainframe environments (e.g., cloning a deployed application instances to a new mainframe computing system, such as for testing purposes) can be very difficult processes. For instance, these processes may typically require a great amount of skill and time. Since these processes are typically software product-specific, manuals for the application may need to be studied extensively before implementing the chosen process via a large number of manual steps in various fields of the mainframe computing system.

### BRIEF SUMMARY

According to at least one embodiment, an auto-discovery process is initiated to gather configuration information for an application instance deployed on a mainframe computing system. A mainframe management agent of the mainframe computing system generates, using the configuration information gathered during the auto-discovery process, an image of the application instance at the application layer that indicates a first set of application artifacts defining a runtime environment for the application. An upgrade template, which defines a workflow for upgrading the application instance and indicates a second set of application artifacts to define a runtime environment for the application, is accessed, and the image of the application instance is modified to include one or more application artifacts from the upgrade template. The mainframe management agent upgrades the application instance deployed on the mainframe computing system based on the modified image of the application instance.

According to at least one embodiment, an auto-discovery process is initiated to gather configuration information for a first instance of an application deployed on a mainframe computing system. A mainframe management agent of the mainframe computing system generates, using the configuration information gathered during the auto-discovery process, an image of the first instance of the application at the application layer. The image indicates a set of application artifacts and variables defining a runtime environment for the first instance of the application. A cloning template, which defines a workflow for cloning the application instance at a second mainframe computing system and indicates a set of application artifacts and variables to define a runtime environment for the application instance, is accessed, and a second instance of the application is provisioned on the second mainframe computing system based on the cloning template and the image of the first instance of the application.

### BRIEF DESCRIPTION OF THE DRAWINGS

FIG. 1 is a simplified diagram of an example computing environment 100 in accordance with at least one embodiment.

FIG. 2 is a simplified block diagram of an example computing device connected to an example mainframe computing system in accordance with at least one embodiment.

FIG. 3 is a simplified diagram of an example workflow for gathering configuration information for an application instance deployed on a mainframe computing system in accordance with at least one embodiment.

FIG. 4 is a flow diagram of an example process of generating an image of a mainframe application instance based on configuration information gathered during an auto-discovery process in accordance with at least one embodiment.

FIG. 5 is a simplified diagram of an example workflow for upgrading an application instance deployed on a mainframe computing system in accordance with at least one embodiment.

FIG. 6 is a flow diagram of an example process of upgrading an application instance deployed on a mainframe computing system in accordance with at least one embodiment.

FIG. 7 is a simplified diagram of an example workflow for online cloning of an application instance deployed on a first logical partition (LPAR) of a mainframe machine to a second logical partition (LPAR) of the mainframe machine in accordance with at least one embodiment.

FIG. 8 is a simplified diagram of an example workflow for offline cloning of an application instance deployed on a logical partition (LPAR) of a first mainframe machine to a logical partition (LPAR) of a second mainframe machine in accordance with at least one embodiment.

FIG. 9 is a flow diagram of an example process of cloning an application instance to a new mainframe computing system in accordance with at least one embodiment.

FIG. 10 is a flow diagram of an example process for implementing the workflows of FIGS. 5-9 in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

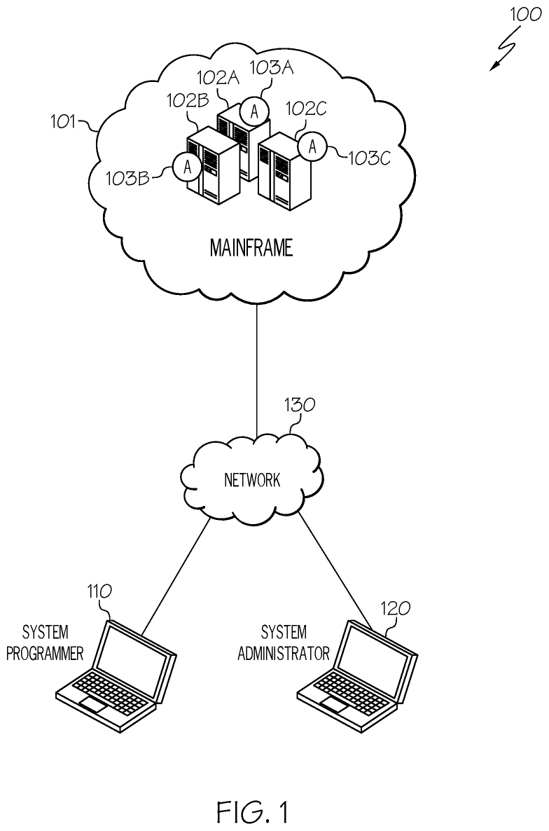

FIG. 1 is a simplified diagram of an example computing environment 100 in accordance with at least one embodiment. The computing environment 100 includes a mainframe system 101, a system programmer 110, and a system administrator 120, all of which are communicably coupled through a network 130. The mainframe system 101 may include one or more mainframe machines (or servers) 102, which may implement different mainframe computing systems that may serve as a centralized computing resource for an entity. The mainframe system 101 may host one or more proprietary software applications 103 which provide computing services for the entity, as well as one or more other applications that support or monitor the proprietary applications (e.g., CA SYSVIEW™, CA Mainframe Software Manager (MSM)™, or other types of applications that run on mainframe computing systems). In some embodiments, the mainframe system 101 may run the applications 103 within a mainframe operating system (e.g., IBM zOS™ or another type of mainframe operating system), which may be managed by a mainframe management agent (e.g., IBM z/OS Management Facility™ (z/OSMF) or another type of mainframe management agent).

The system programmer 110 (or “sysprog”) may manage the mainframe system 101 through a computing device. For example, the system programmer 110 may be a designated person that provisions, installs, customizes, or upgrades applications on the mainframe system 101, or performs other types of maintenance operations on the mainframe system 101. Typically, the system programmer 110 has a high level of experience and skill related to performing such operations on the mainframe system 101. By comparison, the system administrator 120 may be knowledgeable about an application 103 running on the mainframe system 101, but may have less experience or knowledge regarding the maintenance or installation of the application 103 on the mainframe system 101. For example, application upgrades or application cloning may require the time and skill of the system programmer 110 rather than the system administrator 120. Since these processes are typically application-specific, the system programmer 110 may be required to first study product manuals for the application 103 before implementing the relevant upgrade or cloning process, which may require a large number of manual steps in various fields of the mainframe system 101.

However, in certain aspects of the present disclosure, application upgrade or cloning processes may be simplified so that a less experienced system administrator 120 can initiate such processes, requiring less time from the system programmer 110. For instance, the system administrator 120 may initiate an application upgrade/clone process that covers all necessary steps from beginning to end to get the new application instance (either a new software version or cloned instance) up and running without the involvement of the system programmer 110. The process may also be repeatable over different mainframe computing systems (e.g., to a different logical partition (LPAR) of a mainframe machine or different sysplex of mainframe machines). In some embodiments, an installation and verification process (IVP) may be executed after the upgrade/clone process has been completed to ensure the process properly upgraded or cloned the application instance on the target system.

In general, “mainframe machines,” “computing devices,” “systems,” etc. in the example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environments 100, 200 may be implemented using a plurality of computing devices and processors, such as server pools including multiple server computers. Further, servers, clients, network elements, systems, and computing devices can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. In some instances, a server, system, subsystem, or computing device can be implemented as some combination of devices that can be hosted on a common computing system, server, server pool, or cloud computing environment and share computing resources, including shared memory, processors, and interfaces.

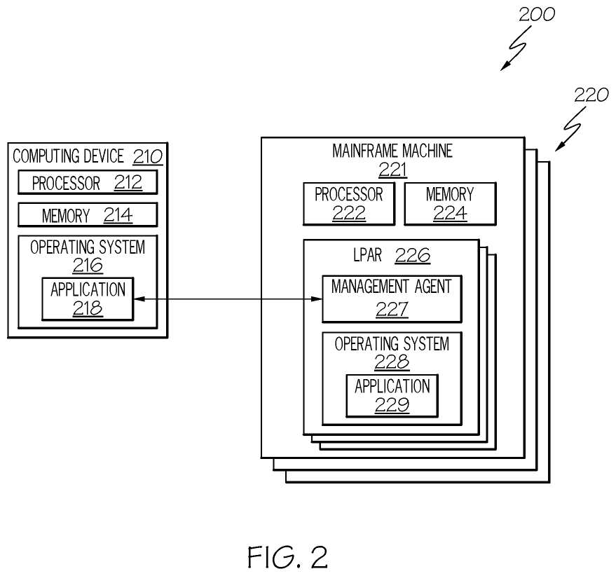

FIG. 2 is a simplified block diagram of an example computing device 210 connected to an example mainframe system 220 in accordance with at least one embodiment. The computing device 210 and mainframe system 220 may be connected by a network (e.g., 130) or in another manner. In the example shown, the mainframe system 220 hosts one or more applications (e.g., 229) that are accessible by the computing device 210. The computing device 210 may be any type of computing device used to access one or more aspects of the mainframe system 220, including aspects of the application(s) (e.g., 229) running on the mainframe system 220, aspects of the mainframe management agent(s) (e.g., 227) running on the mainframe system 220, or other aspects of the mainframe system 220. In some embodiments, for example, the computing device 210 may be used by a system programmer (e.g., 110) or system administrator (e.g., 120).

The computing device 210 includes a processor 212 and memory 214. The computing device executes an operating system 216 that runs an application 218 that may be used by the computing device 210 to access one or more aspects of the mainframe system 220 through an interface (e.g., a wired or wireless network interface, not shown). The example processor 212 executes instructions, for example, to perform one or more of the functions described herein. The instructions can include programs, codes, scripts, or other types of data stored in memory. Additionally, or alternatively, the instructions can be encoded as pre-programmed or re-programmable logic circuits, logic gates, or other types of hardware or firmware components. The processor 212 may be or include a general-purpose microprocessor, as a specialized co-processor or another type of data processing apparatus. In some cases, the processor 212 may be configured to execute or interpret software, scripts, programs, functions, executables, or other instructions stored in the memory 214. In some instances, the processor 212 includes multiple processors or data processing apparatuses. The example memory 214 includes one or more computer-readable media. For example, the memory 214 may include a volatile memory device, a non-volatile memory device, or a combination thereof. The memory 214 can include one or more read-only memory devices, random-access memory devices, buffer memory devices, or a combination of these and other types of memory devices. The memory 214 may store instructions (e.g., programs, codes, scripts, or other types of executable instructions) that are executable by the processor 212.

The mainframe system 220 includes multiple mainframe machines 221, which each include a processor 222 and memory 224. The processor 222 may be implemented similar to the processor 212 of the computing device 210 and the memory 224 may be implemented similar to the memory 214 of the computing device 210; however, the mainframe machine 221 may include additional processing power and/or additional memory capacity when compared with the computing device 210. In the example shown, the mainframe machine 221 implements multiple logical partitions (LPARs) 226, which each implement a respective mainframe management agent 227 (e.g., z/OSMF) and operating system 228 (e.g., zOS). Each LPAR may be considered to be a separate mainframe computing system. For instance, each operating system 228 may run a separate application 229, which may provide one or more computing services to the computing device 210. In some embodiments (not shown in FIG. 2), the mainframe system 220 may implement a mainframe computing system as a sysplex of mainframe machines 221 (e.g., a cluster of mainframe machines 221) that act as a single mainframe computing system, running a single operating system and corresponding mainframe management agent.

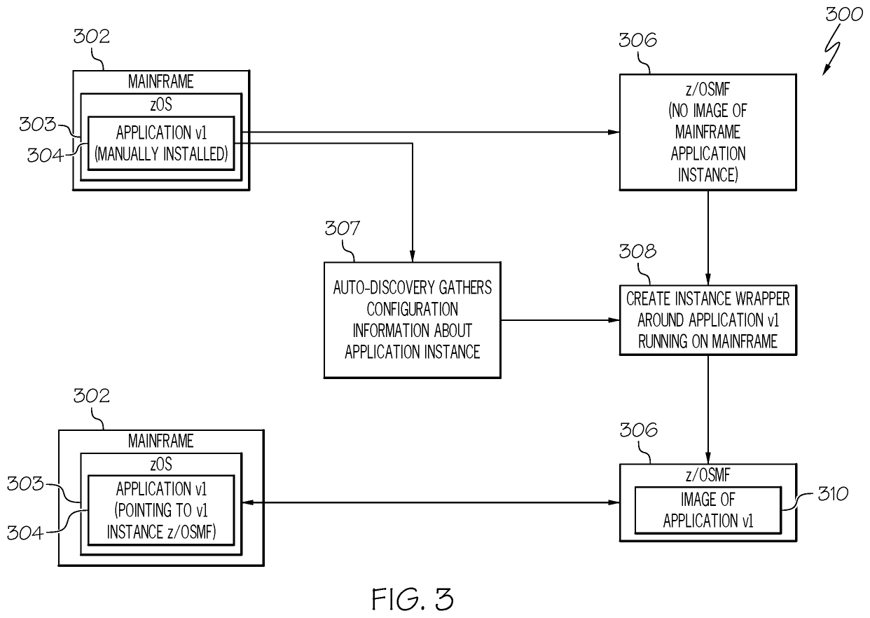

FIG. 3 is a simplified diagram of an example workflow 300 for gathering configuration information for an application instance 304 deployed on a mainframe computing system 302 in accordance with at least one embodiment. The mainframe computing system 302 runs an application 304 inside a mainframe operating system 303 (zOS™, in this example). The mainframe computing system 302 may be implemented as an LPAR of a mainframe machine (e.g., LPAR 226 of mainframe machine 220A of FIG. 2), or as a sysplex of multiple mainframe machines (e.g., multiple mainframe machines 220A connected to one another to implement a single mainframe computing system). The mainframe operating system 303 is connected to a mainframe management agent 306 (z/OSMF™, in this example), which may run on the mainframe computing system 302 (e.g., mainframe management agent 227 on LPAR 227 of FIG. 2) or on another mainframe computing system. The mainframe computing system 302 may be implemented in another manner than that shown.

In the example shown, the application 304 is implemented as a first version (v1) of the application software, and was manually installed (e.g., by a sysprog) onto the mainframe computing system 302. Because the application 304 was manually installed, the mainframe management agent 306 may have no image of the instance of the application 304 on mainframe computing system 302, and may not be utilized to automatically upgrade the existing instance of the application 304 to a new software version (e.g., v2) or to clone the existing instance of the application 304 to a new mainframe computing system (e.g., to a non-production environment for testing purposes).

Accordingly, in some embodiments, an auto-discovery process 307 is initiated to gather configuration information for the v1 instance of the application 304 deployed on the mainframe computing system 302. The auto-discovery process may be initiated by a system programmer (e.g., 110) by specifying a most recently started task for the application instance and a location of the configuration dataset, and the auto-discovery process may automatically read all other application properties. For example, the auto-discovery process 307 may gather a set options, components, values, a list of started tasks, log streams, capture indices, or other artifacts specific to the instance of the application 304.

The mainframe management agent 306 then creates an instance wrapper 308 around the application instance 304, and generates, using the gathered configuration information, an application layer image 310 of the application instance 304 on the mainframe computing system 302. For instance, the image 310 may include or otherwise indicate a set of application artifacts that define a runtime environment for the first software version (v1) of the application 304 (e.g., the configuration information gathered during the auto-discovery process). Once the image 310 has been created by the mainframe management agent 306, the application instance 304 may point to the image 310, and one or more functions of the mainframe management agent 306 may be utilized (e.g., using application programming interfaces (APIs)) to upgrade the application 304 to a new software version or to clone the instance of the application 304 to another mainframe computing system, as described further below.

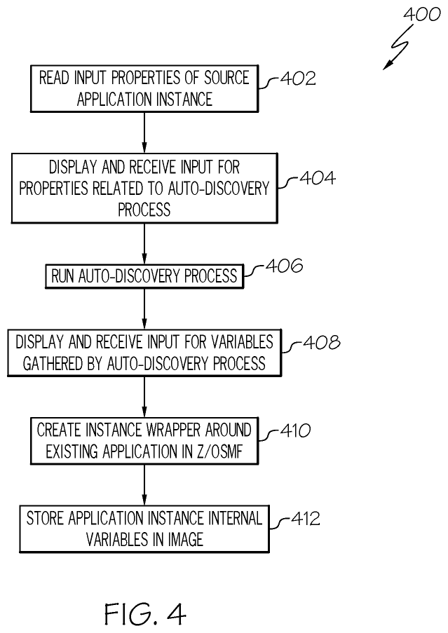

FIG. 4 is a flow diagram of an example process of generating an image of a mainframe application instance based on configuration information gathered during an auto-discovery process in accordance with at least one embodiment. Operations in the example process 400 may be performed by components of, or connected to, a mainframe computing system (e.g., mainframe management agent 306 connected to mainframe computing system 302 of FIG. 3). The example process 400 may include additional or different operations, and the operations may be performed in the order shown or in another order. In some cases, one or more of the operations shown in FIG. 4 are implemented as processes that include multiple operations, sub-processes, or other types of routines. In some cases, operations can be combined, performed in another order, performed in parallel, iterated, or otherwise repeated or performed another manner.

At 402, input properties of a source application instance are read. The source application instance may be the application instance for which the image is to be generated. Referring to the example shown in FIG. 3, the source application instance may refer to the application instance 304 on the mainframe computing system 302. In some cases, the source application may be selected by a user by first selecting a target mainframe computing system (e.g., an LPAR or sysplex) against which a wrapper is to be issued, and then the source application may be selected from a list of supported applications.

At 404, properties related to the auto-discovery process are presented to a user (e.g., a system programmer, such as system programmer 110 of FIG. 1). In some cases, the user may provide input for the properties. For example, the prefix for a load library or release version may be displayed to the user, and the user may enter information for these properties or may modify information automatically displayed for these properties. This may enable customization of the auto-discovery process.

At 406, the auto-discovery process is executed based on the properties displayed at 404 to gather configuration information for the source application instance. For example, the auto-discovery process may gather information related to certain options, components, values, started tasks, log streams, capture indices, or other artifacts specific to the application instance.

At 408, the information gathered by the auto-discovery process at 406 is presented to the user. In some cases, the user may provide input for the information, such as to modify certain variables or other configuration gathered. For example, some options might not be possible to gather automatically through the auto-discovery process (e.g., for corrupted data/libraries, data that is impossible to read from a path (due to permissions, being accidentally deleted, etc.) or some of options specific sub-variables), so these options may be manually set by the user.

At 410, an instance wrapper is created around the existing application in the mainframe management agent (e.g., z/OSMF). In some cases, this may include verifying ability to connect to the source application and verifying a software version/release of the source application instance. The wrapper may set instance variables (from the source application instance perspective, these may be considered as internal variables) based on the previous operations. The wrapper may create an instance representation with a correct setup in z/OSMF (e.g., with internal variables that point to proper artifacts, and application options/features being set correctly).

At 412, the application instance internal variables are stored in an image representing the application instance in the mainframe management agent. Referring to the example shown in FIG. 3, the variables may be stored in the image 310 maintained by the mainframe management agent 306.

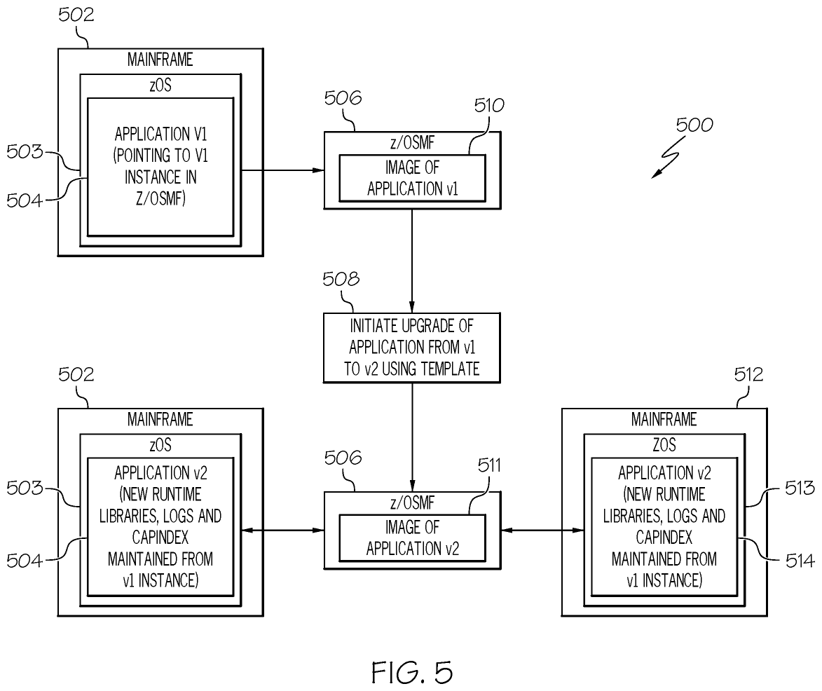

FIG. 5 is a simplified diagram of an example workflow 500 for upgrading an application instance 504 deployed on a mainframe computing system 502 in accordance with at least one embodiment. The mainframe computing system 502 runs an application instance 504 inside a mainframe operating system 503 (zOS™, in this example as well). The mainframe computing system 502 may be implemented as an LPAR of a mainframe machine (e.g., LPAR 226 of mainframe machine 220A of FIG. 2), or as a sysplex of multiple mainframe machines (e.g., multiple mainframe machines 220A connected to one another to implement a single mainframe computing system). The mainframe operating system 503 is connected to a mainframe management agent 506 (z/OSMF™, in this example), which may run on the mainframe computing system 502 (e.g., mainframe management agent 227 on LPAR 227 of FIG. 2) or on another mainframe computing system. The mainframe computing system 502 may be implemented in another manner than that shown. For purposes of illustration and explanation, the mainframe computing system 502 and mainframe management agent 506 of FIG. 5 are considered to be in the same state as the mainframe computing system 302 and mainframe management agent 306 of FIG. 3 after the image 310 has been created.

In the example shown, the mainframe management agent 506 accesses an upgrade template and initiates an upgrade 508 of the application instance image from the first version (v1) to a newer version (v2). The upgrade template defines a workflow for upgrading the application instance 504 to a second version of the application, and indicates a set of application artifacts that define a runtime environment for a second version of the application. In some embodiments, a system programmer (e.g., 110) may provide input to configure or define certain aspects of the upgrade template. For instance, in some cases, a system programmer may configure certain variables of the upgrade template. As an example, a system programmer can overwrite some application options (e.g., for software version v1, option 1 may be set to be active, but the system programmer knows that he does not want this option to be active in software version v2, so it may be deactivated in the workflow property definition), or can enforce different version of Java libraries (e.g., software version v1 runs Java version 1.6, but the system programmer wants the software version v2 to run Java version 1.8, so he overwrites this property with a java path pointing to Java version 1.8, even if in software version v1 ran Java version 1.6; or may do similar operations for 31 bit vs. 64 bit Java, third party libraries, etc.).

In some embodiments, when an upgrade process is initiated on an existing application instance, the workflow can stop the running application (e.g., stop started tasks related to the application instance), and initiate the application upgrade process. If there are some artifacts which are not in need anymore (e.g., because they are obsolete, or not used in new software version), the workflow can retain those artifacts and flag them for a system programmer, unmount those artifacts and delete them, or delete those artifacts if are not mountable (e.g., for old datasets). The workflow may then restart the updated application instance.

The mainframe management agent 506 then modifies the image 510 to include one or more application artifacts from the upgrade template, and then upgrades the application instance 504 to the new software version (v2) based on the modified image 511. Table 1 shows an example set of artifacts for different software versions of the application instance. As shown in Table 1, a subset of the artifacts shown remain the same between the different software application versions, while others (those italicized in Table 1) are changed between the two versions. In some embodiments, the process of upgrading the application may therefore include replacing certain artifacts with newer versions while maintaining the artifacts that are unchanged between the different software versions of the application. For instance, in the example shown, the upgraded (v2) instance of the application 504 includes new runtime libraries, and maintains log streams and one or more capture indices from the previous version (v1) of the application instance.

TABLE 1
Example application artifacts for two software versions

| Artifact | Application v1 | Application v2 |
|---|---|---|
| SAMPJCL | appv1.OSA.SAMPJCL | appv2.OSA.SAMPJCL |
| Runtime libraries | appv1.OSA.CNM4B* | appv2.OSA.CNM4B* |
| SITE libraries | appv1.OSA.SITE.CNM4B* | appv1.OSA.SITE.CNM4B* |
| Capture index | appv1.OSA.CAPINDEX | appv1.OSA.CAPINDEX |
| Log streams | appv1.AUDIT.ADTT.OSA | appv1.AUDIT.ADTT.OSA |
| | appv1.SYSDATAPLOT.OSA | appv1.SYSDATAPLOT.OSA |
| | appv1.SYSDATA.XLOG.OSA | appv1.SYSDATA.XLOG.OSA |
| | appv1.CICSLOGR.TRAN.OSA | appv1.CICSLOGR.TRAN.OSA |
| | appv1.CICSLOGR.TSUM.OSA | appv1.CICSLOGR.TSUM.OSA |
| | appv1.CICSLOGR.SYSD.OSA | appv1.CICSLOGR.SYSD.OSA |
| | appv1.CICSLOGR.EITL.OSA | appv1.CICSLOGR.EITL.OSA |
| | appv1.CICSLOGR.XLOG.OSA | appv1.CICSLOGR.XLOG.OSA |

In some embodiments, the mainframe management agent 506 may use the modified image 511 to update another instance of the application on another mainframe computing system (e.g., on the same mainframe machine or a different mainframe machine as mainframe computing system 502). For instance, in the example shown, the mainframe management agent 506 may use the modified image 511 to update the application instance 414 running on the mainframe computing system 512 (in operating system 513) to the new software version (v2). In some cases, the mainframe computing system 502 is a first LPAR on a mainframe machine and the mainframe computing system 512 is a second LPAR on the same mainframe machine. In other cases, the mainframe computing system 502 is an LPAR on a first mainframe machine and the mainframe computing system 512 is an LPAR on a second mainframe machine. In yet other cases, the mainframe computing system 502 is a first sysplex of mainframe machines and the mainframe computing system 512 is a second sysplex of mainframe machines.

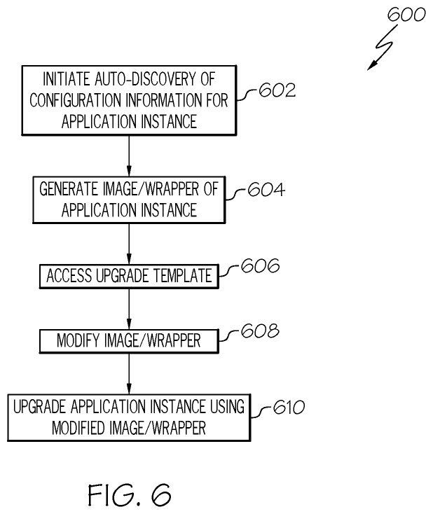

FIG. 6 is a flow diagram of an example process 800 of cloning an application instance to a new mainframe computing system in accordance with at least one embodiment. Operations in the example process 600 may be performed by components of, or connected to, a mainframe computing system (e.g., mainframe management agent 506 connected to mainframe computing system 502). The example process 600 may include additional or different operations, and the operations may be performed in the order shown or in another order. In some cases, one or more of the operations shown in FIG. 6 are implemented as processes that include multiple operations, sub-processes, or other types of routines. In some cases, operations can be combined, performed in another order, performed in parallel, iterated, or otherwise repeated or performed another manner.

At 602, an auto-discovery process is initiated to gather configuration information for an application instance. The application instance may be running on a mainframe computing system, which may include a logical partition (LPAR) of a mainframe machine or a sysplex (cluster) of multiple mainframe machines. The mainframe computing system may run the application inside a mainframe operating system, such as zOS. The application instance may represent a particular software version of the application. For instance, referring to the example shown in FIG. 3, the application instance 304 is a first version (v1) of the application. The auto-discovery process may be implemented according to one or more operations described above with respect to FIGS. 3-4.

At 604, an application layer image of the application instance is generated. The image may be generated, at least in part, by a mainframe management agent that is a part of, or is connected to, the mainframe computing system running the application instance. For example, the mainframe management agent may be z/OSMF where the application instance runs within a zOS environment. The image may indicate a set of application artifacts that define a runtime environment for the current (first) software version of the application. In some cases, the image may include one or more variables associated with the runtime environment for the current (first) software version. For example, the variables may include a Java path, a Java version (e.g., 31 bit vs. 64 bit), a started task name, a started task library location (e.g., where an entity has a policy to have new versions of started tasks in separate libraries), a load library name (e.g., in case a system programmer may wish to overwrite this library with a new version, such as one with a specific fix applied), a user name or userid associated with the started task, third party library location, or another type of variable associated with the runtime environment for the application instance.

At 606, an upgrade template is accessed. The upgrade template may define a workflow for upgrading the application instance to a new software version, and may indicate a set of application artifacts that define a runtime environment for the new (second) software version of the application. In some cases, where the image includes variables, the upgrade template may indicate a set of variables associated with the runtime environment for the new (second) version of the application as well. At least one of the application artifacts or variables indicated in the upgrade template may be different from the corresponding artifact or variable for the first version of the application. In some cases, a system programmer may modify or otherwise provide input regarding one or more of the artifacts or variables.

At 608, the image generated at 604 is modified to include one or more application artifacts from the upgrade template accessed at 606, and at 610, the application instance is upgraded to the new software version based on the modified image generated at 608. In some cases, upgrading the application instance may include replacing one or more runtime libraries associated with the first software version of the application with corresponding runtime libraries associated with the second software version of the application. For example, referring to Table 1 above, the runtime library “appv1.OSA.CNM4B*” associated with the software version v1 may be replaced with the runtime library “appv2.OSA.CNM4B*” associated with the software version v2. In some cases, upgrading the application instance may include maintaining at least a portion of the set of application artifacts from the older application instance in the upgraded application instance. Referring again to Table 1, for example, the SITE libraries, log streams, and capture indices may all be maintained from the software version v1 to software version v2. In some instances, an installation and verification process (IVP) may be executed after the application instance has been upgraded.

In some cases, an application instance other than the one discovered at 602 may be upgraded using the upgrade template. For example, an application instance deployed on a second, different mainframe computing system (e.g., another LPAR) may be upgraded to the new software version using the same upgrade template accessed at 606. This other application instance may be upgraded based on a corresponding application layer image for the instance, which may be generated using an auto-discovery process, similar to that described above with respect to FIGS. 3-4.

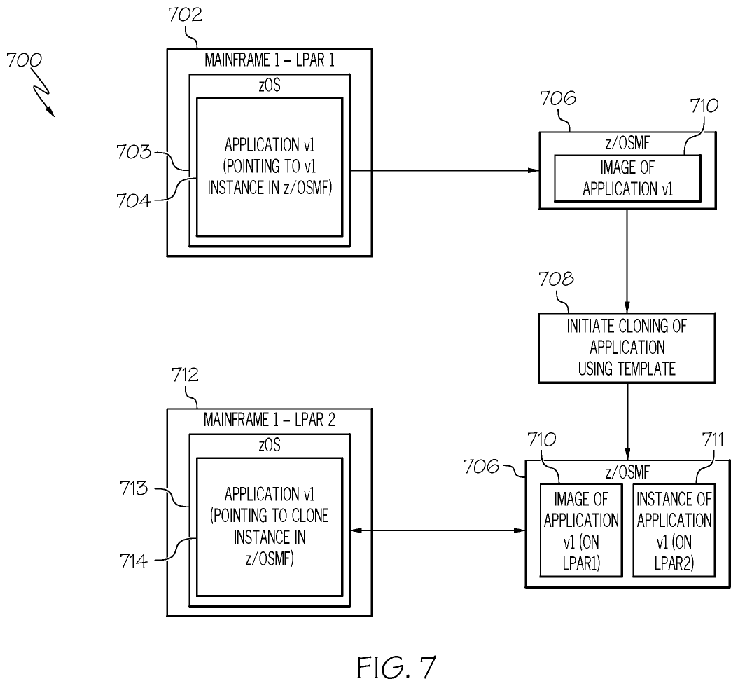

FIG. 7 is a simplified diagram of an example workflow 700 for online cloning of an application instance 704 deployed on a first logical partition (LPAR) 702 of a mainframe machine to a second logical partition (LPAR) 712 of the mainframe machine in accordance with at least one embodiment. The mainframe computing system 702 runs an application instance 704 inside a mainframe operating system 703 (zOS™, in this example as well). The mainframe operating system 703 is connected to a mainframe management agent 706 (z/OSMF™, in this example), which may run on the mainframe computing system 702 (e.g., mainframe management agent 227 on LPAR 227 of FIG. 2) or on another mainframe computing system. The mainframe computing system 702 may be implemented in another manner than that shown. For purposes of illustration and explanation, the mainframe computing system 702 and mainframe management agent 706 of FIG. 7 are considered to be in the same state as the mainframe computing system 302 and mainframe management agent 306 of FIG. 3 after the image 310 has been created.

In the example shown, the mainframe management agent 706 accesses a cloning template, which defines a workflow for cloning the application instance 704 at another mainframe computing system and indicates a set of application artifacts and variables to define a runtime environment for the application instance 704, and initiates cloning (provisioning) of the application instance 704 onto the mainframe computing system 712 (as application instance 714) based on the cloning template and the image 710. In some cases, as a result of the cloning/provisioning of the application instance 714, a new image 711 representing the instance 714 may be created and maintained in the mainframe management agent 706 alongside the image 710 representing the instance 704. In other cases, both application instances 704, 714 may point to the same image 710.

As an example, if LPAR 1 702 and LPAR 2 712 are deployed on a sysplex and have shared disks in the sysplex, it is possible that some or all artifacts could be the same as one another. Thus, instance variables in image 710 and image 711 will point to the same artifact. In such instances, a system programmer can enforce new artifact creation (e.g., copying) for some or all of these artifacts in the clone instance. For example, if both the source and clone instances have the same runtime library, fixes or updates may be applied just to one library, and it will be reflected in both application instances. However, every application instance may have its own log stream (which may be different from the time stamp of clone creation, so the clone isntance would have logs in its own log stream dataset).

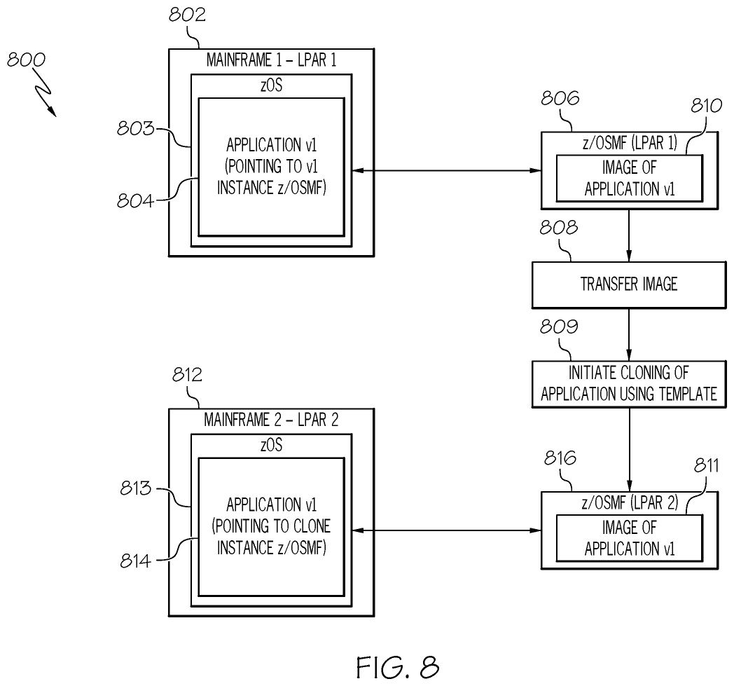

FIG. 8 is a simplified diagram of an example workflow 800 for offline cloning of an application instance 804 deployed on a logical partition (LPAR) 802 of a first mainframe machine to a logical partition (LPAR) 812 of a second mainframe machine in accordance with at least one embodiment. The mainframe computing system 802 runs an application instance 804 inside a mainframe operating system 803 (zOS™, in this example as well). The mainframe operating system 803 is connected to a mainframe management agent 806 (z/OSMF™, in this example), which may run on the mainframe computing system 802 (e.g., mainframe management agent 227 on LPAR 227 of FIG. 2) or on another mainframe computing system. The mainframe computing system 812 may be implemented in a similar manner to the mainframe computing system 802. The mainframe computing systems 802, 812 may be implemented in another manner than that shown. For purposes of illustration and explanation, the mainframe computing system 802 and mainframe management agent 806 of FIG. 8 are considered to be in the same state as the mainframe computing system 302 and mainframe management agent 306 of FIG. 3 after the image 310 has been created.

In the example shown, the mainframe management agent 806 maintains an image 810 of the application instance 804 on the mainframe computing system 802, similar to the image 310 of FIG. 3. In the example shown, the mainframe computing systems 802, 812 are not connected to one another (e.g., via network or other connections). To clone the application instance 804 onto the mainframe computing system 812, the image 810 may copied and/or transferred to the mainframe management agent 816, which may maintain the copy as image 811. The mainframe management agent 816 may then provision a clone of the application instance 804 onto the mainframe computing system 812 as application instance 814 using a cloning template similar to the cloning template described above with respect to FIG. 6.

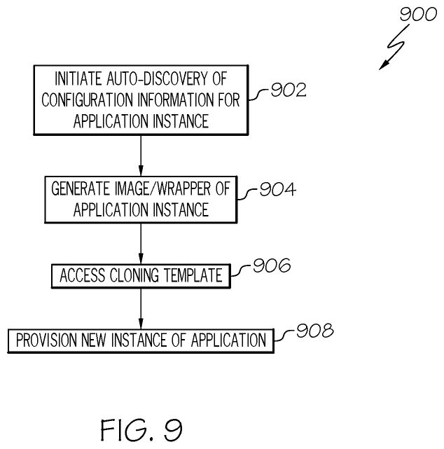

FIG. 9 is a flow diagram of an example process 900 of upgrading an application instance deployed on a mainframe computing system in accordance with at least one embodiment. Operations in the example process 900 may be performed by components of, or connected to, a mainframe computing system (e.g., mainframe management agent 706 connected to mainframe computing systems 702, 712). The example process 900 may include additional or different operations, and the operations may be performed in the order shown or in another order. In some cases, one or more of the operations shown in FIG. 9 are implemented as processes that include multiple operations, sub-processes, or other types of routines. In some cases, operations can be combined, performed in another order, performed in parallel, iterated, or otherwise repeated or performed another manner.

At 902, an auto-discovery process is initiated to gather configuration information for a source application instance running on a mainframe computing system. The source application instance may be running on a mainframe computing system, which may include a logical partition (LPAR) of a mainframe machine or a sysplex (cluster) of multiple mainframe machines. The mainframe computing system may run the application inside a mainframe operating system, such as zOS. The application instance may represent a particular software version of the application. For instance, referring to the example shown in FIG. 3, the application instance 304 is a first version (v1) of the application. The auto-discovery process may be implemented according to one or more operations described above with respect to FIGS. 3-4.

At 904, an application layer image of the application instance is generated. The image may be generated, at least in part, by a mainframe management agent that is a part of, or is connected to, the mainframe computing system running the application instance. For example, the mainframe management agent may be z/OSMF where the application instance runs within a zOS environment. The image may indicate a set of application artifacts (e.g., runtime libraries, capture indices, or log streams) that define a runtime environment for the current (first) software version of the application. In some cases, the image may include one or more variables associated with the runtime environment for the current (first) software version. For example, the variables may include a Java path, a Java version (e.g., 31 bit vs. 64 bit), a started task name, a started task library location (e.g., where an entity has a policy to have new versions of started tasks in separate libraries), a load library name (e.g., in case a system programmer may wish to overwrite this library with a new version, such as one with a specific fix applied), a user name or userid associated with the started task, third party library location, or another type of variable associated with the runtime environment for the source application instance.

At 906, a cloning template is accessed. The cloning template may define a workflow for cloning the source application instance at another mainframe computing system, and may indicate a set of application artifacts and variables that define a runtime environment for the source application instance.

At 908, a new instance of the application is provisioned on another mainframe computing system. The new instance may be a “clone” of the source application instance. In some cases, provisioning the new application instance may include re-using one or more application artifacts of the source application instance. For example, referring to Table 1 above, each of the artifacts listed may be re-used to provision the clone instance. In some cases, the artifacts or datasets of the source instance may be copied to the new mainframe computing system the clone instance is deployed on. In other cases, a pointer may be used to point to the artifacts or datasets of the source application instance. In other cases, a new set of artifacts may be generated for the clone instance, where the new set of artifacts are based on the artifacts of the source application instance.

In some embodiments, the clone instance may be provisioned on another mainframe computing system that is connected to the mainframe management agent that manages the image of the source application instance. This may be referred to as an “online” cloning process. For instance, referring to the example shown in FIG. 7, the source application instance 704 is deployed on a first LPAR 702 of a mainframe machine and the clone instance 714 is deployed on a second LPAR 712 of the same mainframe machine. In such a cloning process, the clone instance provisioning may be initiated based on the image maintained by the mainframe management agent, and after cloning, the mainframe management agent may manage both the source and the clone instance images (e.g., as shown in FIG. 7).

In some embodiments, the clone instance may be provisioned on another mainframe computing system that is not connected to the mainframe management agent that manages the image of the source application instance. This may be referred to as an “offline” cloning process. For instance, referring to the example shown in FIG. 8, the source application instance 804 is deployed on an LPAR 702 (managed by mainframe management agent 706) of a first mainframe machine and the clone instance 714 is deployed on an LPAR 712 (managed by mainframe management agent 716) of a different mainframe machine. In such a cloning process, the image of the source application instance may be transferred (e.g., in a file format) from the source mainframe management agent to target mainframe management agent (e.g., along with the cloning template, if the target system does not otherwise have access to the template), which then initiates the clone instance provisioning based the transferred image and the cloning template.

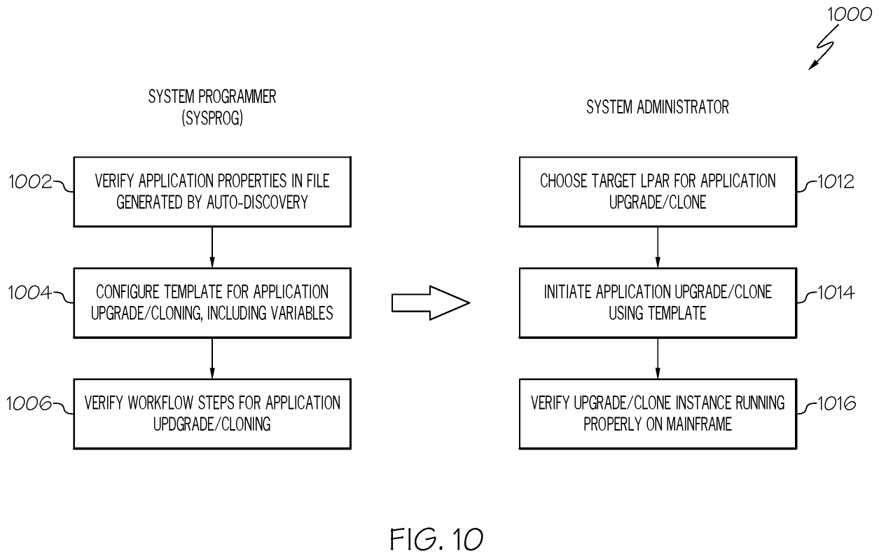

FIG. 10 is a flow diagram of an example process 1000 for implementing the workflows of FIGS. 5-9 in accordance with at least one embodiment. In the example shown, the process 1000 is implemented in part by a system programmer and in part by a system administrator. The example process 1000 may include additional or different operations, and the operations may be performed in the order shown or in another order. In some cases, one or more of the operations shown in FIG. 10 are implemented as processes that include multiple operations, sub-processes, or other types of routines. In some cases, operations can be combined, performed in another order, performed in parallel, iterated, or otherwise repeated or performed another manner. In the example shown a system programmer (or sysprog, e.g., 110 of FIG. 1) performs the operations 1002, 1004, 1006, while a system administrator (e.g., 120 of FIG. 1) performs the operations 1012, 1014, 1016. As explained below, the operations of FIG. 10 may be performed for either application upgrade processes (e.g., process 800 of FIG. 8) or application cloning processes (e.g., process 900 of FIG. 9).

At 1002, the system programmer verifies application properties in one or more files generated by the auto-discovery process described above for an application instance on a mainframe computing system. For example, the application properties may include a list of options, components, values, started tasks, log streams, capture indices, or other artifacts specific to the instance of the application for which the auto-discovery process was run. In some cases, the system programmer may modify one or more variables or other properties, so that the modified properties are propagated to the upgrade/clone application instance. For example, the system programmer may wish to modify activated or installed application options (e.g., may wish to deactivate or activate some options which were activated or deactivated, respectively, in the first or source application instance), activate or deactivate security profile creations (e.g., for shared security profiles among all systems, a system programmer may not want to create the same profile with a new profile since the profile is already there/shared amongst all instances), a Java version, a Java type, Java path, or another type of variable associated with the runtime environment of the application instance.

At 1004, the system programmer configures a template for upgrading the application instance, or for cloning the application instance to another mainframe computing system. The template may be based on the application properties that were obtained by the auto-discovery process and verified and/or modified by the system programmer at 1002. In some cases, configuring the template may include specifying the workflow steps (including security-related steps (e.g., for ACF2, RACF, or TSS) and IVP-related steps) and associated aspects of the steps for performing the application upgrade or cloning process. For example, in some embodiments, the system programmer may specify which workflow steps will run under which userid on the mainframe computing system, as different permissions may be needed be for security- or IVP-related workflow steps. In some cases, the system programmer may specify which users (e.g., which system administrators) may use the template to perform upgrade or clone processes, or which users can approve of a modified template.

At 1006, the system programmer verifies workflow steps associated with the upgrade or cloning template configured at 1004. If all steps are correct, the system programmer may provide the upgrade or cloning template to the system administrator, who may then use the template to initiate application upgrades/clones on different mainframe computing systems. The template may be locked for further modifications by other users. For instance, if the system administrator later identifies a need to change variables or other properties of the application upgrade or clone template, then the system administrator may request such changes to be made by the system programmer.

At 1012, the system administrator chooses a target mainframe computing system for application upgrading/cloning, and at 1014, initiates the upgrade/clone process using the template configured by the system programmer. The process may automatically run each of the workflow steps specified in the upgrade or clone template, including ACF2, RACF, or TSS related steps. Once finished, the workflow may automatically start the new application instance and execute an IVP process to verify the new application instance configuration. In some embodiments, the application upgrade or cloning process may be initiated using an API of the mainframe management agent on the target mainframe computing system (e.g., a z/OSMF API), requiring only a single click by the system administrator.

At 1016, after the upgrade or clone process is complete, the system administrator verifies that the new application instance (upgraded instance or cloned instance) is running properly on the mainframe computing system. This may include verifying that the functions of the application are executing properly, or that the new application instance runtime environment is correct (e.g., correct logs or capture indices are being used). The system administrator may also, in some cases, repeat 1012, 1014, 1016 to upgrade or clone application instances on other mainframe computing systems using the same template.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
initiating an auto-discovery process to gather configuration information for a first instance of an application deployed on a mainframe computing system, wherein the configuration information for the first instance of the application comprises a plurality of application properties, and wherein the initiating is in response to determining a most recently started task of the first instance of the application and a location of a configuration dataset;
generating, by a mainframe management agent of the mainframe computing system, using the configuration information for the first instance of the application gathered during the auto-discovery process, an image of the first instance of the application at the application layer, the image indicating a set of application artifacts and variables defining a runtime environment for the first instance of the application;
accessing a cloning template, the cloning template defining a workflow for cloning the application instance at a second mainframe computing system and indicating a set of application artifacts and variables to define a runtime environment for the application instance; and
provisioning, by the mainframe management agent, a second instance of the application on the second mainframe computing system based on the cloning template and the image of the first instance of the application.

2. The method of claim 1, wherein provisioning the second instance of the application on the second mainframe computing system comprises re-using one or more application artifacts of the first instance of the application.

3. The method of claim 1, wherein provisioning the second instance of the application on the second mainframe computing system comprises copying for at least one application artifact a corresponding dataset of the first instance of the application to the second mainframe computing system.

4. The method of claim 1, wherein provisioning the second instance of the application on the second mainframe computing system comprises using a pointer for at least one application artifact that points to a corresponding dataset of the first instance of the application on the first mainframe computing system.

5. The method of claim 1, wherein provisioning the second instance of the application on the second mainframe computing system comprises generating a set of application artifacts for the second instance of the application based on the set of application artifacts indicated in the image of the first instance of the application.

6. The method of claim 1, wherein the application artifacts of the image comprise one or more of runtime libraries, capture indices, and log streams for the first instance of the application.

7. The method of claim 1, wherein the first mainframe computing system is a first logical partition (LPAR) of a mainframe machine, and the second mainframe computing system is a second LPAR of the mainframe machine.

8. The method of claim 1, wherein the mainframe management agent is a first mainframe management agent on a first mainframe machine, and the method further comprises:
transferring the image of the first instance of the application from the first mainframe management agent to a second mainframe management agent via an offline process; and
provisioning a third instance of the application on a third mainframe computing system on a second mainframe machine.

9. The method of claim 1, further comprising executing an installation verification process on the second mainframe computing system for the second instance of the application.

10. The method of claim 1, wherein the mainframe computing system runs a z/OS operating system that executes the application instance, and the mainframe management agent is a z/OS Management Facility (z/OSMF).

11. A non-transitory computer readable medium having program instructions stored therein, wherein the program instructions are executable by a computer system to perform operations comprising:
obtaining configuration information for a first instance of an application deployed on a mainframe computing system, wherein the configuration information for the first instance of the application comprises a plurality of application properties, and wherein the obtaining is in response to determining a most recently started task of the first instance of the application and a location of a configuration dataset;
generating a wrapper representing the first instance of the application at the application layer, the wrapper indicating a set of application artifacts and variables defining a runtime environment for the first instance of the application;
accessing a cloning template, the cloning template defining a workflow for cloning the application instance at a second mainframe computing system; and
provisioning a second instance of the application on the second mainframe computing system based on the cloning template and the image of the first instance of the application.

12. The non-transitory computer readable medium of claim 11, wherein provisioning the second instance of the application on the second mainframe computing system comprises re-using one or more application artifacts of the first instance of the application.

13. The non-transitory computer readable medium of claim 11, wherein provisioning the second instance of the application on the second mainframe computing system comprises copying for at least one application artifact a corresponding dataset of the first instance of the application to the second mainframe computing system.

14. The non-transitory computer readable medium of claim 11, wherein provisioning the second instance of the application on the second mainframe computing system comprises using a pointer for at least one application artifact that points to a corresponding dataset of the first instance of the application on the first mainframe computing system.

15. The non-transitory computer readable medium of claim 11, wherein provisioning the second instance of the application on the second mainframe computing system comprises generating a set of application artifacts for the second instance of the application based on the set of application artifacts indicated in the image of the first instance of the application.

16. A system comprising:
a data processing apparatus;
a memory; and
a mainframe management agent, executable by the data processing apparatus to:
obtain configuration information for a first instance of an application deployed on a mainframe computing system, wherein the configuration information for the first instance of the application comprises a plurality of application properties, and wherein the obtaining is in response to determining a most recently started task of the first instance of the application and a location of a configuration dataset;
generate a wrapper representing the first instance of the application at the application layer, the wrapper indicating a set of application artifacts and variables defining a runtime environment for the first instance of the application;
access a cloning template, the cloning template defining a workflow for cloning the application instance at a second mainframe computing system; and
provision a second instance of the application on the second mainframe computing system based on the cloning template and the image of the first instance of the application.

17. The system of claim 16, wherein provisioning the second, instance of the application on the second mainframe computing system comprises re-using one or more application artifacts of the first instance of the application.

18. The system of claim 16, wherein provisioning the second instance of the application on the second mainframe computing system comprises copying for at least one application artifact a corresponding dataset of the first instance of the application to the second mainframe computing system.

19. The system of claim 16, wherein provisioning the second instance of the application on the second mainframe computing system comprises using a pointer for at least one application artifact that points to a corresponding dataset of the first instance of the application on the first mainframe computing system.

20. The system of claim 16, wherein provisioning the second instance of the application on the second mainframe computing system comprises generating a set of application artifacts for the second instance of the application based on the set of application artifacts indicated in the image of the first instance of the application.
